(19) United States
(12) Patent Application Publication
(10) Pub. No.: US 2004/0173678 A1
(43) Pub. Date: Sep. 9, 2004

(54) Card reader

(75) Inventor: Mei Ching Wu, Pingcheng City (TW)

Correspondence Address: BACON & THOMAS, PLLC, 625 SLATERS LANE, FOURTH FLOOR, ALEXANDRIA, VA, 22314

(73) Assignee: DATAFAB SYSTEMS INC., Pingcheng City (TW)

(21) Appl. No.: 10/379,696

(22) Filed: Mar. 6, 2003

(51) Int. Cl. G06K 7/06

(52) U.S. Cl. 235/441

(57) ABSTRACT

The present invention is to provide a card reader, which comprises a circuit board including two interface modules, a data conversion module, and a control module, wherein the two interface modules can be coupled to a USB connector or a cassette connector compatible with PCMCIA respectively to enable the control module to couple the data conversion module and the related interface module together so that an electronic device coupled to the other end of the USB connector or the cassette connector can read data from or write data into a memory card inserted in the card reader via the related interface module and the data conversion module.

### FIELD OF THE INVENTION

The present invention relates to card readers and more particularly to such a card reader with improved characteristics.

### BACKGROUND OF THE INVENTION

Technology particularly electronics has known a rapid, spectacular development leading to an increasing use of electronic products. Further, features of an electronic product are more powerful and advanced as compared with that of a similar product. Recently, there is a trend of developing compact electronic products such as notebook computers, digital cameras, digital camcorders, cellular phones, and PDAs (Personal Digital Assistants). Further, they are portable for ease of carry while traveling. As such, a data storage device incorporated therein must be significantly reduced in size. Hence, all major data storage device manufacturers endeavor to continuously develop various memory cards. For one type of memory cards having a fixed size, their memory have increased from several MB to several hundreds MB and even up to 1 GB in its latest model. In other words, increase of data storage capacity of a memory card is constantly being sought.

However, the prior art memory cards suffered from several disadvantages. For example, they are not the same in size and protocol being used and are not compatible one another because they are manufactured by different manufacturers. This can bring inconvenience in use. In this regard, card reader manufacturers continuously develop all-in-one card readers for reading the memory cards. Such all-in-one card readers comprise, for example, four-in-one card reader provided by IBM, six-in-one card reader provided by Jinway Company, and seven-in-one card reader provided by Jimyoung Company. Each of the above card readers can read one of a variety of memory cards in the same platform. However, only ports compatible with USB (Universal Serial Bus) or PCMCIA (Personal Computer Memory Card International Association) are provided on the platform. In such configuration, it is impossible of temporarily disconnecting the card reader from a coupled electronic product for reading the memory card when a port compatible with USB or PCMCIA is being used. This can cause troubles and bring inconvenience. For instance, a user desires to remove a peripheral from one of the ports for connecting the peripheral to the card reader. But he/she also worries that it is impossible of removing the peripheral being used immediately. Alternatively, the peripheral must operate in conjunction with the card reader. As a result, there is no way of connecting the card reader to the electronic product.

Thus, it is desirable to provide a plurality of ports on a card reader for coupling to an electronic product or being matingly connectable to connectors of the electronic product so as to facilitate a connection of the card reader to the electronic product and read various memory cards.

### SUMMARY OF THE INVENTION

A primary object of the present invention is to provide a card reader enclosed in a housing. On a surface of the housing there are provided a first port, a second port, and a slot. Within the housing there is provided a circuit board including a first interface module, a second interface module, a data conversion module, and a control module. The first interface module is coupled to the first port and the control module respectively. The second interface module is coupled to the second port and the control module respectively. The slot is coupled to the data conversion module. The data conversion module is coupled to the first interface module or the second interface module as controlled by the control module. After the first port being coupled to a USB connector, the control module couples the data conversion module and the first interface module together so that an electronic device coupled to the other end of the USB connector can read data from or write data into a memory card via the first interface module, the data conversion module, and the slot. Alternatively, after the second port being coupled to a cassette connector compatible with PCMCIA, the control module couples the data conversion module and the second interface module together so that the electronic device coupled to the other end of the cassette connector can read data from or write data into the memory card via the second interface module, the data conversion module, and the slot.

The above and other objects, features and advantages of the present invention will become apparent from the following detailed description taken with the accompanying drawings.

### BRIEF DESCRIPTION OF THE DRAWINGS

FIG. 1 is a block schematic diagram of circuitry of a card reader according to the invention;

FIG. 2 is a flow chart illustrating a process according to the invention;

FIG. 3 is a flow chart illustrating a process of inserting a memory card into a slot according to the invention; and

FIG. 4 is a perspective view of the card reader shown in FIG. 1.

### DETAILED DESCRIPTION OF THE PREFERRED EMBODIMENTS

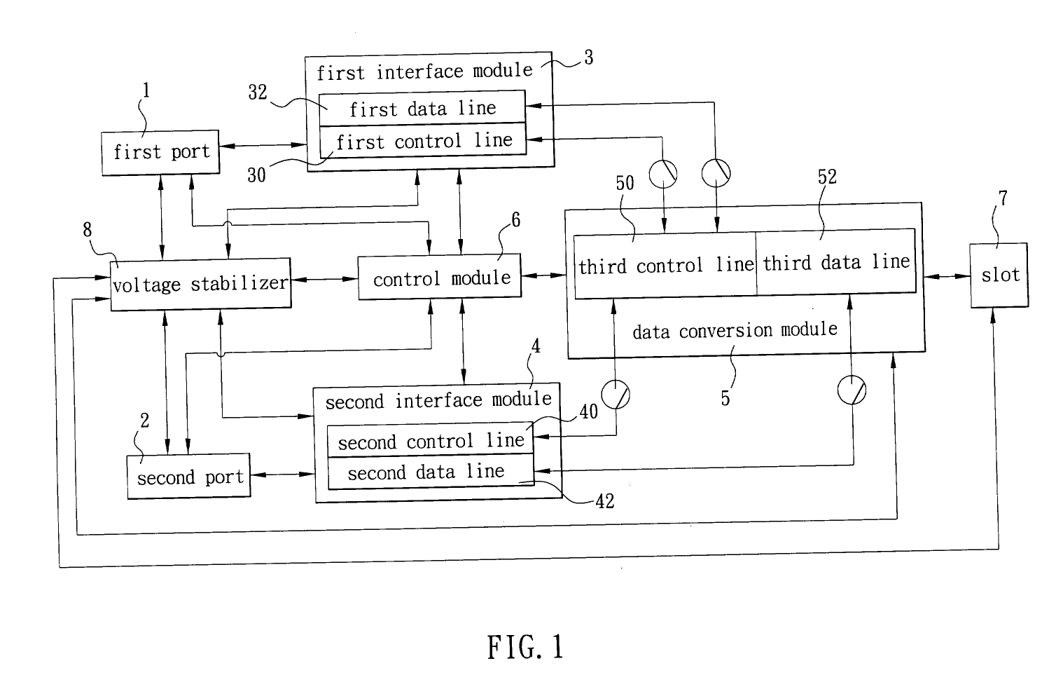

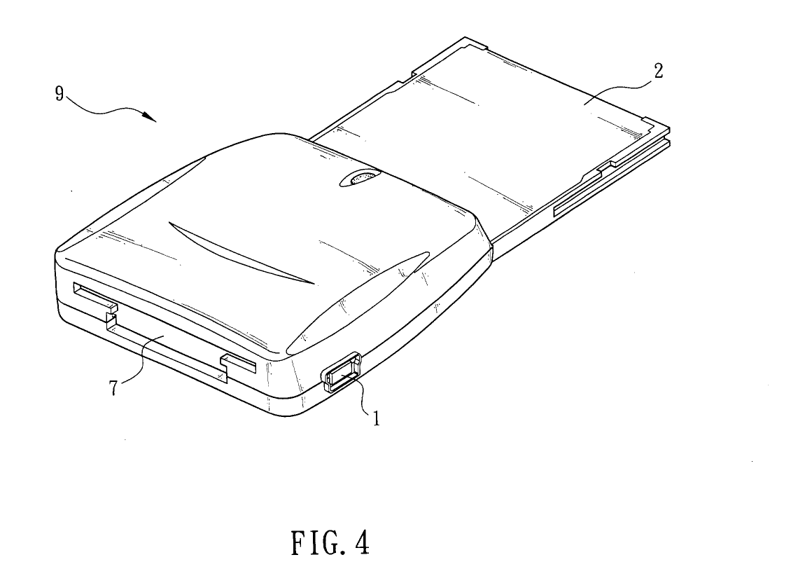

Referring to FIGS. 1 and 4, there is shown a card reader in accordance with the invention. The card reader is enclosed in a housing 9. On a surface of the housing 9 there are provided a first port 1 compatible with USB, a second port 2 compatible with PCMCIA, and a slot 7. Within the housing 9 there is provided a circuit board (not shown). On the circuit board there are provided a first interface module 3 compatible with USB, a second interface module 4 compatible with PCMCIA, a data conversion module 5, and a control module 6. The first interface module 3 is coupled to the first port 1 and the control module 6 respectively. The second interface module 4 is coupled to the second port 2 and the control module 6 respectively. The slot 7 is coupled to the data conversion module 5. The data conversion module 5 is coupled to the first interface module 3 or the second interface module 4 as controlled by the control module 6.

When the control module 6 detects that the first port 1 is inserted into a connector compatible with USB (i.e., USB connector), the control module 6 may couple the data conversion module 5 and the first interface module 3 together. In response to an insertion of a memory card into the slot 7, the first interface module 3 may read data from or write data into the memory card via the data conversion module 5. Further, read data can be sent to an electronic device (e.g., computer or digital camera) coupled to the other end of the USB connector.

When the control module 6 detects that the second port 2 is inserted into a cassette connector compatible with PCMCIA, the control module 6 may couple the data conversion module 5 and the second interface module 4 together. In response to an insertion of a memory card into the slot 7, the second interface module 4 may read data from or write data into the memory card via the data conversion module 5. Further, read data can be sent to an electronic device coupled to the other end of the cassette connector.

In a preferred embodiment of the invention as shown in FIG. 1, the first interface module 3 comprises a first control line 30 and a first data line 32. The second interface module 4 comprises a second control line 40 and a second data line 42. The data conversion module 5 comprises a third control line 50 and a third data line 52. When the control module 6 detects a connection of the first port 1 and the USB connector, the control module 6 can couple the first control line 30 and the third control line 50 together and couple the first data line 32 and the third data line 52 together respectively. As such, the first interface module 3 can issue a command to read data from or write data into the memory card via the first control line 30 and the third control line 50. Further, the first interface module 3 can transfer read/written data via the first data line 32 and the third data line 52.

When the control module 6 detects a connection of the second port 2 and the cassette connector, the control module 6 can couple the second control line 40 and the third control line 50 together and couple the second data line 42 and the third data line 52 together respectively. As such, the second interface module 4 can issue a command to read data from or write data into the memory card via the second control line 40 and the third control line 50. Further, the second interface module 4 can transfer read/written data via the second data line 42 and the third data line 52.

On the circuit board there is further provided a voltage stabilizer 8 for applying a stable voltage to each of the first port 1, the second port 2, the slot 7, the first interface module 3, the second interface module 4, the data conversion module 5, and the control module 6. As a result, the above components can be electrically protected.

In the embodiment, the control module 6 comprises a firmware which can be executed for enabling the control module 6 to continuously detect whether the first port 1 is coupled to the USB connector as well as control a connection of the first control line 30 and the third control line 50 and a connection of the first data line 32 and the third data line 52 respectively. Moreover, the executed firmware enables the control module 6 to continuously detect whether the second port 2 is coupled to the cassette connector as well as control a connection of the second control line 40 and the third control line 50 and a connection of the second data line 42 and the third data line 52 respectively.

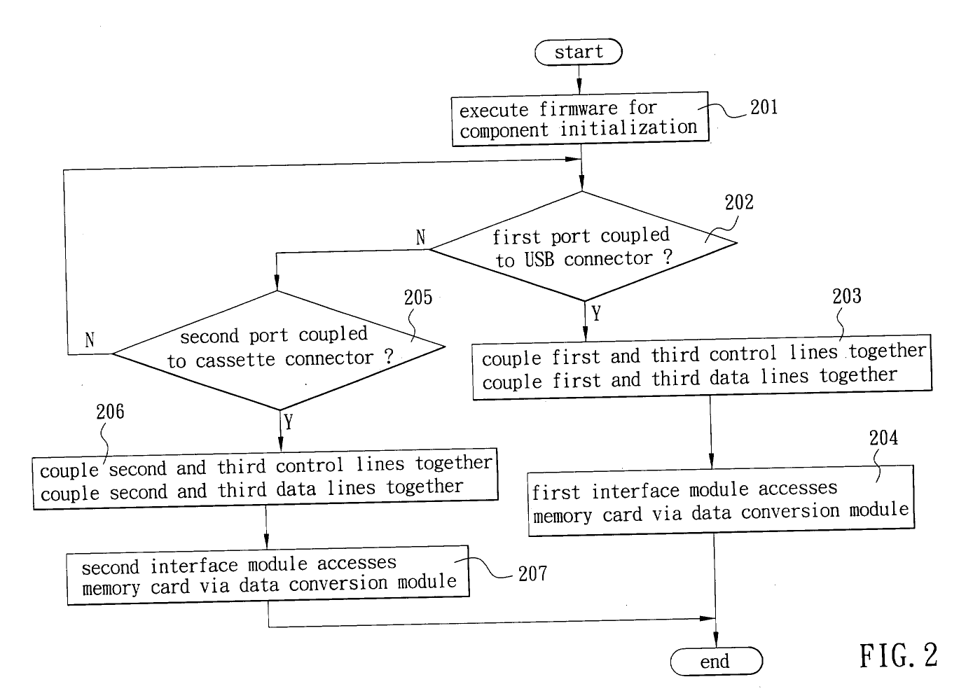

For a further description of the control of the associated components by the firmware, a flow chart illustrating the control process will now be described by referring to FIG. 2 in conjunction with FIG. 1 as below.

In step 201, first the card reader is powered for initializing its components. In step 202, it is determined whether the first port 1 is coupled to the USB connector. If yes, the process goes to step 203. Otherwise, the process jumps to step 205. In step 203, couple the first control line 30 and the third control line 50 together and couple the first data line 32 and the third data line 52 together respectively. In step 204, the first interface module 3 can read data from or write data into the memory card via the data conversion module 5 and maintain the same. The process ends immediately. In step 205, it is determined whether the second port 2 is coupled to the cassette connector. If yes, the process goes to step 206. Otherwise, the process loops back to step 202. In step 206, couple the second control line 40 and the third control line 50 together and couple the second data line 42 and the third data line 52 together respectively. In step 207, the second interface module 4 can read data from or write data into the memory card via the data conversion module 5 and maintain the same. The process ends immediately.

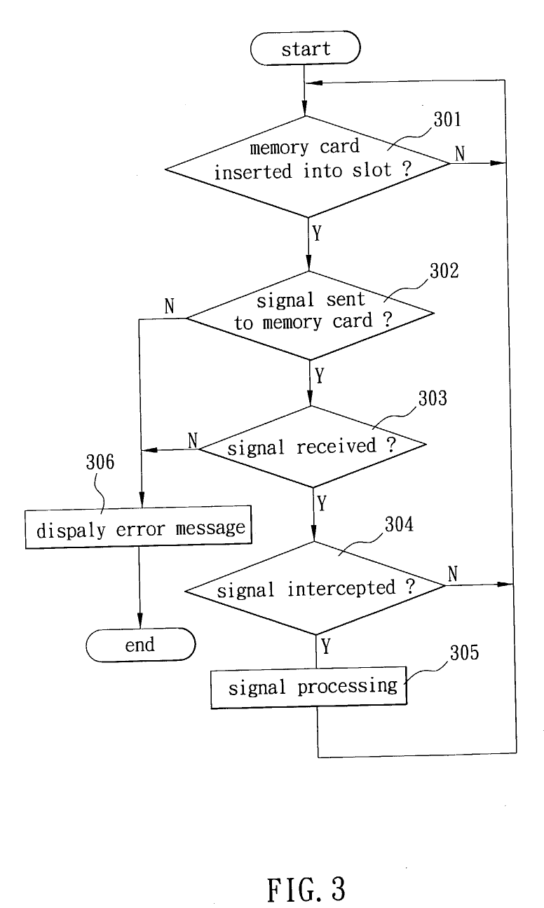

In the embodiment, when the first interface module 3 or second interface module 4 reads data from or writes data into the memory card via the data conversion module 5 and maintains the same, a flow chart illustrating a control process of the associated components as the firmware is executed will now be described by referring to FIG. 3 in conjunction with FIG. 1 as below.

In step 301, first it is determined whether the memory card is inserted into the slot 7. If yes, the process goes to step 302. Otherwise, the process loops back to itself. In step 302, it is determined whether a signal is sent to the memory card. If yes, the process goes to step 303. Otherwise, the process jumps to step 306. In step 303, it is determined whether the signal sent from the memory card is received. If yes, the process goes to step 304. Otherwise, the process jumps to step 306. In step 304, it is determined whether the signal is intercepted. If yes, the process goes to step 305. Otherwise, the process loops back step 301. In step 305, a processing is done on the signal prior to looping back to step 301. In step 306, display an error message on the electronic device coupled to the other end of the USB connector or the cassette connector.

In the embodiment, one of a variety of memory cards can be inserted into the slot 7. The memory cards comprise, but not limited to, Memory Stick, Multimedia Card, Smart Card, and Secure Digital. Further, data stored in the memory card can be converted by the data conversion module 5 into a read/write form of the first interface module 3 or the second interface module 4.

In brief, after powering the card reader if the first port 1 is coupled to the USB connector or the second port 2 is coupled to the cassette connector, the control module 6 can either couple the first interface module 3 and the data conversion module 5 together or couple the second interface module 4 and the data conversion module 5 together. As such, the card reader is ready to read data from the memory card inserted into the slot 7. Also, the specification of the memory card can be identified by the data conversion module 5 so that data stored in the memory card can be converted by the data conversion module 5 into a read/write form of the first interface module 3 or the second interface module 4. Hence, the card reader can couple to the electronic device by connecting the ports to the corresponding connectors of the electronic device. Moreover, the electronic device can read one of a variety of memory cards via the card reader. As a result, it is possible of avoiding conditions of incapable of coupling the card reader to the electronic device and incapable of reading the memory card.

While the invention has been described by means of specific embodiments, numerous modifications and variations could be made thereto by those skilled in the art without departing from the scope and spirit of the invention set forth in the claims.

What is claimed is:

1. A card reader comprising:
a housing;
a first port compatible with USB, the first port being disposed on the housing and being adapted to insert into a USB connector;
a second port compatible with PCMCIA, the first port being disposed on the housing and being adapted to insert into a cassette connector compatible with PCMCIA;
a slot disposed on the housing, the slot being adapted to receive one of a variety of memory cards;
a circuit board within the housing;
a first interface module compatible with USB, the first interface module being disposed on the circuit board;
a second interface module compatible with PCMCIA, the second interface module being disposed on the circuit board;
a data conversion module disposed on the circuit board, the data conversion module being selectively coupled to the first interface module or the second interface module and being coupled to the slot for converting data stored in the memory card into a read/write form of the first interface module or the second interface module; and
a control module disposed on the circuit board, the control module being coupled to the first interface module, the second interface module, and the data conversion module wherein when the control module either detects a connection of the first port and the USB connector the control module couples the data conversion module and the first interface module together, or detects a connection of the second port and the cassette connector the control module couples the data conversion module and the second interface module together.

2. The card reader of claim 1, wherein the first interface module comprises a first control line and a first data line, the second interface module comprises a second control line and a second data line, and the data conversion module comprises a third control line and a third data line so that either in response to the connection of the first port and the USB connector, the control module couples the first and the third control lines together and couples the first and the third data lines together respectively or in response to the connection of the second port and the cassette connector, the control module couples the second and the third control lines together and couples the second and the third data lines together respectively.

3. The card reader of claim 1, further comprising a voltage stabilizer on the circuit board for applying a stable voltage to each of the first port, the second port, the slot, the first interface module, the second interface module, the data conversion module, and the control module.

4. The card reader of claim 1, wherein the control module comprises a firmware, the firmware being executed for enabling the control module to continuously detect whether the first port is coupled to the USB connector and control a connection of the first and the third control lines and a connection of the first and the third data lines; and enabling the control module to continuously detect whether the second port is coupled to the cassette connector and control a connection of the second and the third control lines and a connection of the second and the third data lines respectively.
